(19) United States
(12) Patent Application Publication
(10) Pub. No.: US 2014/0266871 A1
(43) Pub. Date: Sep. 18, 2014

(54) Method for Satellite Beacon Signal Detection and Antenna Alignment

(71) Applicant: ASC SIGNAL CORPORATION, Plano, TX (US)

(72) Inventor: Thomas J. Ellis, Dallas, TX (US)

(73) Assignee: ASC SIGNAL CORPORATION, Plano, TX (US)

(21) Appl. No.: 13/843,095

(22) Filed: Mar. 15, 2013

(51) Int. Cl. H01Q 3/00

(52) U.S. Cl. CPC H01Q 3/00
USPC 342/354

(57) ABSTRACT

A method for detecting a beacon signal, by receiving a beacon signal and processing the beacon signal with respect to a local copy of the beacon signal. The processing including multiplying the beacon signal with a local copy of the beacon signal and integrating the result to generate a background noise filtered beacon signal output. The beacon signal output may be utilized to align an antenna with the beacon signal by adjusting alignment until the beacon signal output is either maximized or minimized, depending upon the function applied.

### BACKGROUND

1. Field of the Invention

This invention relates to satellite antenna tracking. More particularly, the invention relates to antenna alignment with a satellite via satellite beacon signal processing in combination with a local copy of the beacon signal, enabling monitoring of the received beacon signal level by an antenna, for example, below a noise floor of a receiver.

2. Description of Related Art

Satellite communication systems typically utilize high gain ground antennas to overcome the limited power available for the satellite transmitter and high path losses due to the large distances.

While the high gain of the ground antennas allows the received signals to be detected even at low transmission power levels, the high gain of these antennas typically results in a very narrow main lobe antenna signal pattern characteristic. Therefore, aligning the antenna's main beam with the satellites position in orbit is a critical aspect of the communication system.

Most satellites transmit a fixed, known signal to help receiving stations on the ground properly align their antennas to maximize the received signal level. A specific fixed frequency is used by each satellite (rather than relying on whatever information is being transmitted) so a ground station will have a known signal to search for when aligning. However, this fixed “beacon” signal is transmitted at a much lower power level than the signals carrying the information because of the limited power available on an orbiting satellite. This can make receiving the beacon signal difficult when the “beacon” is very close in frequency to other signals that are at much higher power levels or when the level of the beacon signal is close to the system's noise floor.

The gain of a large ground station antenna initially decreases slowly within the main beam as alignment moves off axis, then falls off rapidly further from the axis. This can make keeping the antenna aligned for maximum reception difficult. One common technique to aid in tracking is to add and subtract the outputs of multiple antennas to form a “monopulse” pattern representing an amount of misalignment the antenna has (from the nominal, perfect alignment). As demonstrated in FIG. 1, in conventional systems the difference pattern, which is the higher resolution variation of this monopulse, can be detected only up to the point where it falls below the noise floor of the receiver system, limiting the minimum pointing error that can be detected.

Additionally, depending on the absolute signal levels the system noise floor will limit how deep within the null (which is theoretically zero) the system can track.

Competition in the communications market has focused attention on improving electrical performance while minimizing overall manufacturing, installation and maintenance costs. Therefore, it is an object of the invention to provide a satellite antenna tracking system and method that overcomes deficiencies in the prior art.

### BRIEF DESCRIPTION OF THE DRAWINGS

The accompanying drawings, which are incorporated in and constitute a part of this specification, illustrate embodiments of the invention, where like reference numbers in the drawing figures refer to the same feature or element and may not be described in detail for every drawing figure in which they appear and, together with a general description of the invention given above, and the detailed description of the embodiments given below, serve to explain the principles of the invention.

FIG. 1 is a schematic signal diagram demonstrating monopulse sum and difference patterns, with respect to a longitudinal boresight axis of the antenna and the signal level of an exemplary system RF noise floor.

FIG. 2 is a representative plot of the resulting beacon signal indicator level from the processing scheme illustrated in FIG. 3, demonstrating that the beacon signal indicator level can be detected (and thereby tracked) even if its absolute level falls below the system noise floor.

FIG. 3 is a schematic process diagram for beacon signal indication reception, utilizing a “local” copy of the beacon, receiver and an integrator to develop a beacon signal indicator (V_{beacon}) that is proportional to the level of incoming signal, but not proportional to any other incoming signals or noise.

### DETAILED DESCRIPTION

Satellite beacon signals are typically fixed in amplitude and/or frequency and may also be slowly modulated. Therefore, a copy of the desired satellite beacon signal may be stored locally and/or generated on demand. The inventor has recognized that by multiplying the received satellite signal with a local copy of the beacon signal, a constant dc term “A/2” is obtained, only if the received signal includes a component of the beacon signal, otherwise the resulting products contain only sinusoidal terms. When integrated over time the sinusoidal terms tend to zero while the constant term grows. This dc term may be used as an antenna alignment indicator, even where the signal level of the beacon signal is below the noise floor of the rf environment the beacon signal is transmitted within.

For example:

$$A \cdot cos ( 2 π \cdot {f}_{{beacon}_{( xmit )}} \cdot t ) * cos ( 2 π \cdot {f}_{{beacon}_{( local )}} \cdot t ) = \frac{A}{2} cos ( 2 π \cdot ( {f}_{{beacon}_{( xmit )}} - {f}_{{beacon}_{( local )}} ) \cdot t ) + \frac{A}{2} cos ( 2 π \cdot ( {f}_{{beacon}_{( xmit )}} - {f}_{{beacon}_{( local )}} ) \cdot t )$$

if this is integrated over one period (for example over time), where ƒ_{beacon}_{₍ₓₘᵢₜ₎}=ƒ_{beacon}_{_{(local)}} a dc term A/2 representative of the presence and proportional in value to the magnitude of the beacon signal will always be obtained:

$${\int }_{0}^{T} [ \frac{A}{2} + \frac{A}{2} cos ( 2 π \cdot 2 \cdot {f}_{beacon} \cdot t ) ] = {\int }_{0}^{T} \frac{A}{2} + {\int }_{0}^{T} \frac{A}{2} cos ( 2 π \cdot 2 \cdot {f}_{beacon} \cdot t ) = \underbrace{ \frac{A}{2} + 0}$$

However, for any components of the received signal where ƒ_{beacon}_{₍ₓₘᵢₜ₎}≠ƒ_{beacon}_{_{(local)}} the integration results in

$${\int }_{0}^{T} \frac{A}{2} cos ( 2 π \cdot ( {f}_{{beacon}_{( xmit )}} - {f}_{{beacon}_{( local )}} ) \cdot t ) + {\int }_{0}^{T} \frac{A}{2} cos ( 2 π \cdot ( {f}_{{beacon}_{( xmit )}} - {f}_{{beacon}_{( local )}} ) \cdot t ) = 0$$

which will remain true for all signals (including noise) not “locked” to the local beacon signal frequency.

The repetitive function applied in the example is cosine. Alternatively, one skilled in the art will appreciate that the function may be virtually any repetitive waveform, and the result may be treated as a beacon signal indicator output that becomes a minimum with increasing slope approaching the longitudinal bore sight axis, for example as shown in FIG. 1, increasing precision of the alignment indication.

As demonstrated schematically in FIG. 3, a method for detecting a satellite beacon signal utilizes an antenna and a receiver. Multiplying of the received signal with a local copy of the beacon signal may be performed utilizing a beacon signal generated with a local oscillator or the like. Alternatively, the received signal may be processed into a digital signal via a digital signal processor or the like and multiplied by a local copy of the beacon signal that is a digital representation of the desired beacon signal, for example stored in a memory or generated for processing according to a stored function. Once the received signal and the local beacon signal copy are available in digital form, further processing of both the multiplication and integration functions may be performed entirely digitally, for example within a computer, which may improve overall system reliability and reduce RF processing equipment requirements.

Utilizing digital processing also provides the advantage of enabling the ready storage of a large number of local copies of beacon signals corresponding to a large number of satellites. Such storage may be in a memory coupled to the computer or generated on demand via functions stored in a memory coupled to the computer.

The inverse relationship between the cosine and sin sinusoid or other repetitive functions may be utilized for improved precision of the alignment feedback. For example, after first roughly aligning until the result is a beacon signal maximum, via processing with the cosine function, further processing in smaller alignment increments may be performed, searching for the further repeating function alignment wherein the result is a minimum. Thereby, both overall alignment time required may be minimized and precision of the final alignment with the advantage of the much steeper sin/repetitive function slope characteristic may be maximized, without the prior noise floor precision limitations.

Where in the foregoing description reference has been made to materials, ratios, integers or components having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

We claim:

1. A method for aligning an antenna, comprising the steps of:
receiving a beacon signal;
providing a local copy of the beacon signal;
processing the beacon signal by multiplying the beacon signal with the local copy of the beacon signal; integrating a result of the multiplication of the beacon signal with the local copy of the beacon signal to generate a beacon signal indicator output and
aligning the antenna to a position wherein a signal level of the beacon signal indicator output indicates the alignment has been optimized.

2. The method of claim 1, wherein the beacon signal is converted into a digital signal, prior to processing.

3. The method of claim 2, wherein the processing is performed by a computer.

4. The method of claim 2, wherein the local copy of the beacon signal is a digital copy of the beacon signal, stored in a memory.

5. The method of claim 2, wherein the local copy of beacon signal is generated by a function stored in a memory.

6. The method of claim 1, wherein the local copy of the beacon signal is generated by an oscillator.

7. The method of claim 1, wherein the aligning of the antenna is via a first increment.

8. The method of claim 7, further including the step of applying a repetitive function and aligning the antenna to a position wherein a signal level of the background noise filtered beacon signal output is minimized, via a second increment.

9. The method of claim 8, wherein the second increment is less than the first increment.

10. The method of claim 1, wherein the beacon signal received has a signal strength below a noise floor of an RF environment the beacon signal is transmitted within.

11. A method for detecting a beacon signal, comprising the steps of:
receiving a beacon signal;
providing a local copy of the beacon signal;
processing the beacon signal by multiplying the beacon signal with the local copy of the beacon signal; integrating a result of the multiplication of the beacon signal with the local copy of the beacon signal to generate a beacon signal indicator output; and
indicating the presence of the beacon signal if the beacon signal indicator output is greater than zero.

12. The method of claim 12, wherein the beacon signal is converted into a digital signal, prior to processing.

13. The method of claim 13, wherein the processing is performed by a computer.

14. The method of claim 13, wherein the local copy of the beacon signal is a digital copy of the beacon signal, stored in a memory.

15. The method of claim 13, wherein the local copy of beacon signal is generated by a function stored in a memory.

16. The method of claim 12, wherein the local copy of the beacon signal is generated by an oscillator.

17. The method of claim 12, wherein the beacon signal received has a signal strength below a noise floor of an RF environment the beacon signal is transmitted within.
